(19) United States
(12) Patent Application Publication
(10) Pub. No.: US 2025/0317215 A1
(43) Pub. Date: Oct. 9, 2025

(54) COHERENT MULTI-BEAM OPTICAL PHASED ARRAY FOR RF BEAMFORMING

(71) Applicant: HUAWEI TECHNOLOGIES CO., LTD., Shenzhen (CN)

(72) Inventors: Mitchell NICHOLS, Kanata (CA); Armaghan ESHAGHI, Kanata (CA)

(21) Appl. No.: 19/244,907

(22) Filed: Jun. 20, 2025

Related U.S. Application Data
(63) Continuation of application No. PCT/CN2022/141730, filed on Dec. 24, 2022.

(51) Int. Cl. H04B 10/61; H04B 10/516

(52) U.S. Cl. CPC H04B 10/6165; H04B 10/516

(57) ABSTRACT

A coherent multi-beam optical phased array for radio-frequency beamforming is provided. The optical phase array includes an optical signal source generating an optical signal, a first set of waveguides connected to the optical signal source and configured to propagate the optical signal, a second set of waveguides, a set of splitters along each of the first set of waveguides configured to split the optical signal, a phase shifter coupled to each of the splitters, each phase shifter being controllable to modify a phase shift of the optical signal, a coupler connected to each of the phase shifters and to one waveguide of the second set of waveguides for introducing the optical signal after shifting, and a photodetector coupled to each waveguide of the second set of waveguides and configured to receive a heterodyne optical signal from the waveguide and generate a corresponding electrical signal.

### CROSS-REFERENCE TO RELATED APPLICATIONS

This application is a continuation of PCT/CN2022/141730 filed on Dec. 24, 2022, the entire contents of which are incorporated herein by reference.

### TECHNICAL FIELD

The present disclosure relates to radio-frequency communications, and, in particular, to coherent multi-beam optical phased arrays for radio-frequency beamforming.

### BACKGROUND

The next generations of wireless communication networks (i.e., 5G and 6G) will be required to provide very high data rates (10 Gbps or more), ultra-low latency (less than 1 ms), high reliability, and low energy consumption. Millimeter-wave (mmWave) communication (above 24 GHz) is expected to be one of the key enablers of enhanced mobile broadband service that will improve the capacity of 5G wireless systems through access to the largely untapped high-band frequencies. Operating at mm Wave frequencies offers much higher bandwidth and orders of magnitude higher data rates. Moreover, based on the shorter wavelength of mm Wave signals, massive number of antenna elements can be deployed in a relatively small area, which results in the multiple-input multiple-output (MIMO) concept for mm Wave communications. MIMO systems can resolve the poor propagation characteristics of mm Wave channels such as increased path loss and severe channel intermittency by employing beamforming techniques.

Beamforming is a spatial signal processing technique that focuses the transmitted or received signal power of an antenna array to create a directional link between a base station (BS) and user equipment (UEs). A single antenna A radiates signals in all directions, following the nature of electromagnetic wave, as shown in FIG. 1A. Having multiple antennas A as is shown in FIGS. 1B and 1C provides an opportunity to focus signals in a specific direction; i.e., to form a targeted beam of electromagnetic energy. The overlapping waves caused by the antennas A produce interference that, in some areas, is constructive, making the signal stronger, and, in other areas, is destructive, making the signal weaker or undetectable. If executed correctly, this beamforming process can focus the signal according to the desired pattern.

In a simple scenario with a single path, multiple radiating elements can transmit the same signal at an identical wavelength but with different phases such that the strength of the combined received signal at a specific direction is enhanced. By focusing a signal in a specific direction, beamforming allows for the delivery of higher signal quality to the receiver. This results in faster information transfer and fewer errors without the need to boost broadcast power.

### SUMMARY

In accordance with a first aspect of the present disclosure, there is provided a coherent multi-beam optical phased array for radio-frequency beamforming, comprising: an optical signal source generating an optical signal; a first set of waveguides connected to the optical signal source and configured to propagate the optical signal; a second set of waveguides; a set of splitters along each of the first set of waveguides configured to split the optical signal; a phase shifter coupled to each of the splitters, each of the phase shifters being controllable to modify a shift in a phase of the optical signal received from a corresponding splitter of the set of splitters; a coupler connected to each of the phase shifters and to one waveguide of the second set of waveguides for introducing the optical signal after shifting; and a photodetectors coupled to each waveguide of the second set of waveguides and configured to receive a heterodyne optical signal from the waveguide and generate a corresponding electrical signal.

In some or all examples of the first aspect, at least one of the waveguides in the second set of waveguides can be coupled to each of the waveguides in the first set of waveguides via a subset of the splitters.

In some or all examples of the first aspect, the coherent multi-beam optical phased array can further comprise: an optical source signal splitter coupled to the optical signal source and configured to split the optical signal among a subset of the first set of waveguides.

In some or all examples of the first aspect, the coherent multi-beam optical phased array can further comprise: an optical modulator positioned between the optical source signal splitter and each of the subset of the first set of waveguides.

In some or all examples of the first aspect, the first set of waveguides can be in a first layer and the second set of waveguides can be in a second layer that is offset spatially from the first layer.

In some or all examples of the first aspect, the coherent multi-beam optical phased array can further comprise: an optical local oscillator coupled to the second set of waveguides with a controllable frequency offset from the first optical signal to up-convert or down-convert the frequency of the electrical signal generated at the photodetector.

In some or all examples of the first aspect, the phase shifter can be a phase change materials phase shifter that includes a layer of chalcogenide deposited on a waveguide layer. The layer of chalcogenide can be, for example, one of an antimony-selenium layer and a GSST (Ge₂Sb₂Se₄Te), and the waveguide layer can be one of a silicon layer and a silicon nitride (Si₃N₄) layer.

In accordance with a second aspect of the present disclosure, there is provided a coherent multi-beam optical phased array for radio-frequency beamforming, comprising: an optical signal source generating an optical signal; a first set of waveguides connected to the optical signal source and configured to propagate the optical signal; a second set of waveguides; a set of splitters along each of the first set of waveguides configured to split the optical signal; a phase shifter coupled to each of the splitters, each of the phase shifters being controllable to modify a shift in a phase of the optical signal received from a corresponding splitter of the set of splitters, the phase shifter being coupled to one of the wave guides in the second set of waveguides; a coupler connected to the waveguides in the second set of waveguides extending from at least two of the phase shifters for combining the optical signal after shifting by the at least two phase shifters; and a set of photodetectors coupled to each coupler and configured to receive a heterodyne optical signal from the coupler and generate a corresponding electrical signal.

In some or all examples of the second aspect, the coupler can combine the optical signal after shifting from each of the first set of waveguides.

In some or all examples of the second aspect, the coherent multi-beam optical phased array can further comprise: an optical source signal splitter coupled to the optical signal source and configured to split the optical signal among a subset of the first set of waveguides.

In some or all examples of the second aspect, the coherent multi-beam optical phased array can further comprise: an optical modulator positioned between the optical source signal splitter and each of the subset of the first set of waveguides.

In some or all examples of the second aspect, the first set of waveguides can be in a first layer and the second set of waveguides can be in a second layer that is offset spatially from the first layer.

In some or all examples of the second aspect, the coherent multi-beam optical phased array can further comprise: an optical local oscillator coupled to the second set of waveguides with a controllable frequency offset from the first optical signal to up-convert or down-convert the frequency of the electrical signal generated at the photodetector.

In some or all examples of the second aspect, the phase shifter can be a phase change materials phase shifter that includes a layer of chalcogenide deposited on a waveguide layer. The layer of chalcogenide can be, for example, one of an antimony-selenium layer and a GSST (Ge₂Sb₂Se₄Te) layer, and the waveguide layer can be, for example, one of a silicon layer and a silicon nitride (Si₃N₄) layer.

In accordance with a third aspect of the present disclosure, there is provided a coherent multi-beam optical phased array for radio-frequency beamforming, comprising: a phase change materials phase shifter.

In some or all examples of the third aspect, the phase change materials phase shifter can include a layer of chalcogenide deposited on a waveguide layer. The layer of chalcogenide can be, for example, one of an antimony-selenium layer and a GSST (Ge₂Sb₂Se₄Te) layer. The waveguide layer can be, for example, one of a silicon layer and a silicon dioxide layer.

In some or all examples of the third aspect, a silicon dioxide (SiO₂) layer can be positioned between the layer of chalcogenide and the waveguide layer.

Other aspects and features of the present disclosure will become apparent to those of ordinary skill in the art upon review of the following description of specific implementations of the application in conjunction with the accompanying figures.

### BRIEF DESCRIPTION OF THE DRAWINGS

FIG. 1A shows electromagnetic radiation emitted from a single antenna.

FIGS. 1B and 1C show electromagnetic radiation emitted from at least two antennas, enabling the formation of directable beams.

FIG. 2A is a schematic diagram of a transmitter driven by a digital-to-analog converter,

FIG. 2B is a schematic diagram of a receiver driven by a digital-to-analog converter.

FIGS. 3A and 3B are schematic diagrams of digital beamformers.

FIG. 4 is a schematic diagram of a hybrid beamformer.

FIG. 5A are schematic diagrams of beamformers employing Blass matrices.

FIG. 6A is a schematic diagram of a beamformer architecture.

FIG. 6B shows an expanded view from region 6B in FIG. 6A.

FIG. 6C shows a waveguide coupler in accordance with an alternative embodiment.

FIG. 7 is a schematic diagram of a beamformer architecture in accordance with another embodiment.

FIGS. 8A and 8B are schematic diagrams of beamformer architectures similar to those of FIGS. 6A and 7, wherein the components are distributed across two layers.

FIG. 9 is a schematic diagram of a beamformer architecture similar to that of FIG. 6A, wherein frequency up-conversion and down-conversion is achieved via a optical local oscillator.

FIG. 10A shows a PCM phase shifter with SbSe on an SOI platform.

FIG. 10B shows a PCT phase shifter with GSST on a SiN platform.

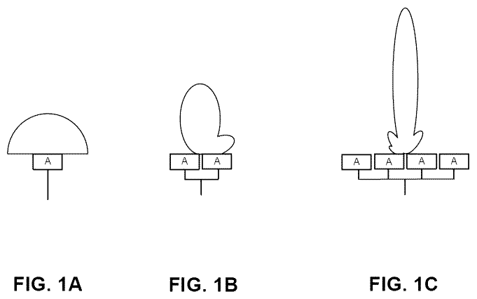

Unless otherwise specifically noted, articles depicted in the drawings are not necessarily drawn to scale.

### DETAILED DESCRIPTION OF EXAMPLE EMBODIMENTS

The present disclosure is made with reference to the accompanying drawings, in which embodiments are shown. However, many different embodiments may be used, and thus the description should not be construed as limited to the embodiments set forth herein. Rather, these embodiments are provided so that this application will be thorough and complete. Wherever possible, the same reference numbers are used in the drawings and the following description to refer to the same elements, and prime notation is used to indicate similar elements, operations or steps in alternative embodiments. Separate boxes or illustrated separation of functional elements of illustrated systems and devices does not necessarily require physical separation of such functions, as communication between such elements may occur by way of messaging, function calls, shared memory space, and so on, without any such physical separation. As such, functions need not be implemented in physically or logically separated platforms, although such functions are illustrated separately for ease of explanation herein. Different devices may have different designs, such that although some devices implement some functions in fixed function hardware, other devices may implement such functions in a programmable processor with code obtained from a machine-readable medium. Lastly, elements referred to in the singular may be plural and vice versa, except wherein indicated otherwise either explicitly or inherently by context.

Generally, there are three basic architectures for mm Wave beamforming, including analog beamforming, hybrid beamforming, and digital beamforming.

Analog beamforming is implemented by a phased array with a single radio frequency (RF) chain driven by a digital-to-analog converter (DAC) in the transmitter or an analog-to-digital converter (ADC) in the receiver, as shown in FIGS. 2A and 2B respectively. The antenna weights in the phased array are constrained to be phase shifts that can be controlled using analog components. The phases of the phase shifters are typically quantized to limited resolution, and can be dynamically adjusted based on specific strategies to steer the beam. The main drawback of analog beamforming is that only one data stream can be supported at a time. The architecture has low power consumption, but high insertion loss with many antennas due to the number of signal divisions.

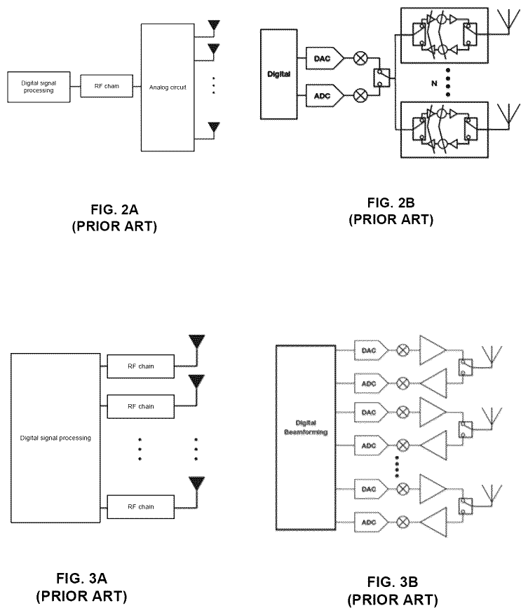

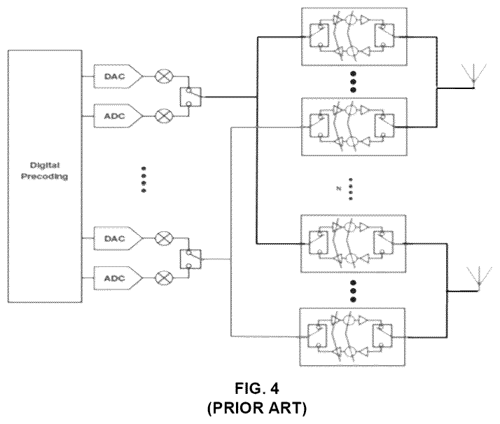

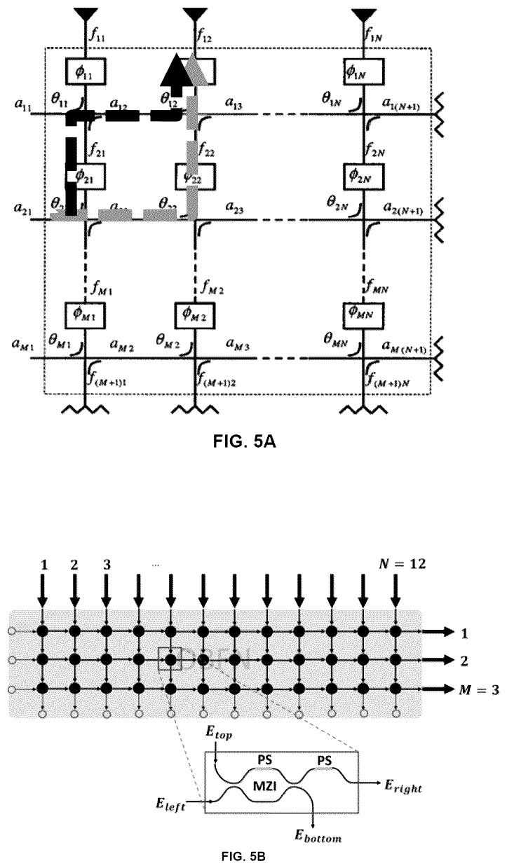

In digital beamforming, one RF chain is allocated to each antenna, which makes digital beamforming more flexible than analog beamforming in terms of signal processing, as illustrated in FIGS. 3A and 3B. The required phase shifting and weighting of the antenna signals are performed in a digital signal processing (DSP) unit. Digital beamforming can support higher number of data streams as compared to the analog beamforming architecture. However, the electronic components in each RF chain have large power consumption, and the signal processing required in digital beamforming architectures is of high complexity.

Hybrid beamforming has been proposed to partially address the challenges in both analog and digital beamforming architectures. This architecture is a two-stage beamforming architecture which is constructed by concatenation of a low-dimensional digital (baseband) beamformer and an RF (analog) beamformer implemented using phase shifters. Hybrid beamforming architectures are preferred in multi-user massive MIMO systems in the mm-wave frequency bands as they offer concurrent support of multiple data streams at a lower cost and complexity over digital beamformers. FIG. 4 illustrates a hybrid beamforming architecture in which the output of each of the RF chains is connected to all the antenna elements. Such architecture is called “fully-connected” hybrid beamforming. Hybrid beamforming architectures that are not fully-connected are “partially-connected”, so that the output of each of the RF chains is only connected to some of the antenna elements.

Although hybrid beamforming can provide advantages over each of the digital and analog beamforming architectures, in electronic implementations, the analog portion of a hybrid beamformer suffers from insertion losses and transmission line losses that increase with the number of antenna elements due to the number divisions in the signal path and the length of the transmission lines. This requires embedded amplifiers in the beamforming network (BFN) to maintain signal powers at a useable level. Partially-connected architectures are generally used due to the complexity of the feed network that requires a large number of signal crossings to connect the transceiver chains to the antenna elements. This reduces the array gain of the beamformer, which limits the range and spatial multiplexing capabilities of the transceiver.

Proposed herein is an alternative solution to the challenges of the electronic-based architectures mentioned above that utilizes photonics-based beamforming techniques, which may incorporate RF/optical and optical/RF converters at the beamformer interfaces with the beamforming carried out exploiting optical technology. The optical technology can be embodied in integrated circuits and can result in beamformers of small size, low weight, low insertion loss, and with potentially low production and installation costs. Generally, RF photonic signal processing techniques for beamforming applications can offer significant performance benefits over electronic approaches due to tunability, high bandwidth, and compact form factor of optical components. Moreover, photonic circuits are immune to electromagnetic interference and have lower propagation losses in silicon waveguides.

Photonic beamforming solutions can follow a coherent architecture, in which the light sources for each signal path are coherent and power combining is performed in the optical domain. This approach is advantageous as it can use only a single wavelength source and relaxes the bandwidth requirements of the photonic circuit components. Phase control to preserve coherence through each signal path is required. Incoherent architectures generally use a multi-wavelength source with power combining realized through mixing of the photocurrents after detection. This approach relaxes the requirements for phase synchronization at the cost of higher optical bandwidth requirements and multiple light sources. The present disclosure describes a novel architecture for coherent optical beamforming.

Prior work on optical multi-beam phased arrays has primarily considered optical implementations of known beamforming architectures, such as Blass and Butler matrices. The Butler matrix is constrained to square arrays (i.e., arrays with a number of beams equal to the number of antennas), and is therefore not well suited to massive MIMO applications in which the number of antennas is much greater than the number of beams. The Blass matrix, illustrated in FIGS. 5A and 5B, consists of a rectangular mesh network with 2×2 couplers at each intersection and phase shifters in each interconnecting waveguide along the vertical columns. This structure can be implemented efficiently in an optical circuit using Mach-Zehnder interferometers as 2×2 couplers with a phase shifter in one of the output arms. With careful design of the coupling ratios and phase shift values, a superposition of complex excitation vectors weighted by the input signal values can be generated at the output ports of the array. This beamforming architecture is beneficial as it can achieve suitable power efficiencies (80%+) and enables dynamic configuration of the beam shape (i.e., the power coupling ratio to each antenna).

Dynamic configuration of the beam directions in the Blass matrix is challenging, however, as the weak isolation between signal paths leads to spurious beams if the spurious paths are not accounted for when configuring the couplers and phase shifters. The number of spurious paths between each input and output grows rapidly with the size of the array, which may be prohibitive to real-time beam steering in large scale antenna arrays.

Disclosed herein is one or more embodiments based on a novel architecture for a coherent optical signal distribution network in a multi-beam phased array transceiver (alternatively referred to as a beamformer herein). The architecture aims to significantly reduce the control complexity of the beamformer in comparison to a Blass matrix, considering both the electronic circuits required to configure the couplers and phase shifters, as well as the algorithm for determining the required coupling ratios and/or phase shifts to achieve a desired array pattern.

In this approach, inputs and outputs in the feed network are coupled through power splitters, couplers and waveguide crossings with a single phase shifter per path to ensure that the array pattern for each beam can be synthesized independently. Coherent optical detection is employed to generate the output RF signals, with integrated frequency conversion in some embodiments. Optical phase shifters are realized with phase change materials to reduce the control complexity and static power consumption of the beamformer.

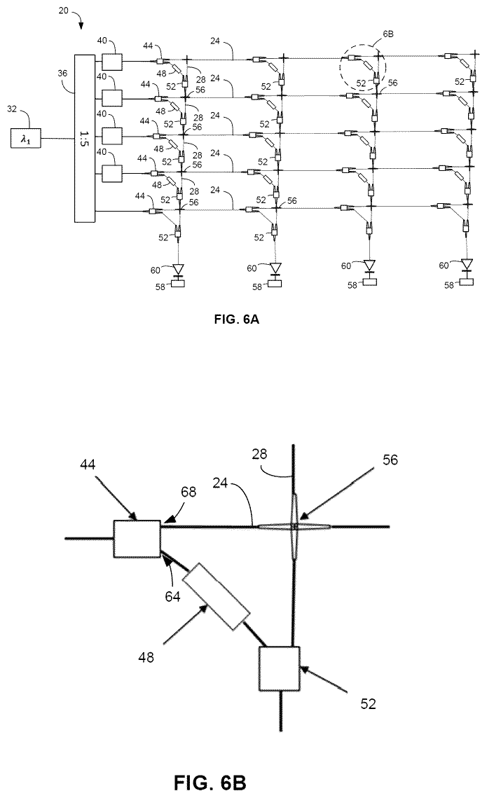

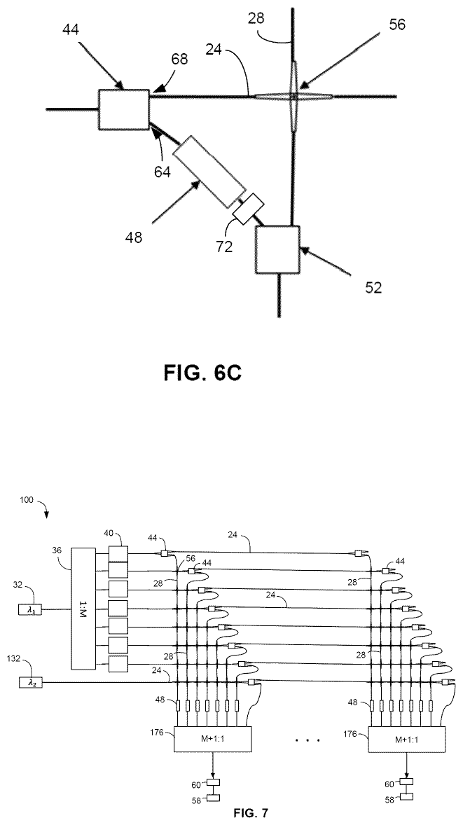

FIGS. 6A and 6B shows a coherent multi-beam optical phased array 20 for radio-frequency beamforming in accordance with an embodiment. The feed network consists of an M×N crossbar array (5×4 in the illustrated example) with 2×2 couplers at the intersections. Ideally, the 2×2 couplers fully isolate each path, but there may be a negligible amount of leakage between paths (e.g., 40 dB or less). The crossbars include a first set of five waveguides 24 and a second set of four waveguides 28 that are not coupled directly to the first set of waveguides. A primary optical signal source 32 generates an optical signal that is split by a 1:5 optical source signal splitter 36 before being fed into each of the five waveguides 24 in the first set. Four of the five waveguides 24 pass through an optical modulator 40. The optical modulator 40 converts RF/IF/BB signals at the beamformer input into the optical domain. A set of couplers in the form of 1:2 splitters 44 are positioned along each of the five waveguides 24, with one of the two branches being coupled to a corresponding phase shifter 48. The phase shifter 48 is connected to a corresponding one of the four waveguides 28 in the second set via a 2:1 coupler 52. A set of waveguide crossings 56 facilitates routing from the waveguides 24 in the first set to waveguides 28 in the second set at the nearest points along their paths. The size of the input vector determines the number of rows (that is, waveguides 24 in the first set) in the matrix, while the size of the output vector determines the number of columns (that is, waveguides 28 in the second set).

The input signals are split along the waveguides 24 in the first set, and combined along the waveguides 28 in the second set. The splitting ratios along the rows are configured to generate the desired beam shapes, while the coupling ratios are configured to balance the losses across different signal paths.

The input to the crossbars (that is, the waveguides 24 in the first set) is an optical signal generated by the optical signal source 32 split into M paths and modulated by the M baseband (BB), intermediate frequency (IF), of RF signals to be transmitted through an array of antennas 60 (alternatively referred to herein as antenna units) or by the NRF or IF signals received at the antenna array (receiver configuration). The optical modulators are configured to generate a single sideband suppressed carrier (SSB-SC) signal. One approach for generating an SSB-SC signal is to use a dual-parallel Mach-Zehnder modulator with specific phase shifters applied to the electrical and optical signals so that the carrier and one of the sidebands are suppressed when the outputs from the two sub-modulators are combined. Another approach for generating an SSB-SC signal is to use an ordinary intensity or phase modulator to generate a DSB or SSB signal, followed by a bandpass filter to isolate one of the sidebands. Each SSB-SC signal propagates along a row of the crossbar matrix through series cascaded 2×2 couplers that couple a portion of the optical signal traversing the row of the crossbar (that is, the waveguide 24 of the first set) into the columns (that is, the waveguides 28 of the second set) with a configurable phase shift effected by the phase shifter 48. The 2×2 couplers consist of unbalanced 1:2 splitters 44, 2:1 couplers 52, optical phase shifters 48, and waveguide crossings 56. The splitter/coupler ratios and the optical phase shifters 48 are configured to generate the desired excitation vectors for each beam generated by the corresponding antenna unit 58. For example, a uniform beam profile requires a uniform power coupling from each row to each column. The 1:2 power splitting ratio along each row, from column 1 to N, must therefore be 1/N, 1/(N−1), . . . 1. Along the columns, the power coupling ratio, from row 1 to row M, must be 1, ½, . . . , 1/M. At the output of the feed network, the optical carrier or optical local oscillator is coupled into the columns of the crossbar for coherent detection at an array of M (receiver configuration) or N (transmitter configuration) photodetectors 60. The photodetectors 60, in turn, generate corresponding analog electrical signals that are fed to the antenna units 58.

FIG. 6B depicts the 2×2 coupler at each intersection of the rows and columns in the crossbar matrix. The 2×2 coupler includes the unbalanced 1:2 splitter 44 that splits a fraction of the input signal to a coupled port 64, which is connected to the phase shifter 48, while the remaining light passes through a transmitted port 68, which propagates to the next crossbar unit through the waveguide crossing 56. The signal exiting the coupled port is phase shifted within the range 0-2π by the optical phase shifter 48, then coupled into the column waveguide through the coupler 52. The coupling ratios of the splitter 44, the coupler 52, and the phase shifter 48 are configured to generate the desired beam shape and direction. The couplers 44, 52 may be implemented by passive devices such as directional couplers or multi-mode interferometers, or active devices such as Mach-Zehnder interferometers. The phase shifters 48 can be any type of optical phase modulator such as thermo-optic, electro-optic, stress-optic, etc.

The crossbar unit is fully reciprocal. If the input signal is applied vertically to the coupler 52 (that is, if the input signal is received from an antenna 60), then the coupler 52 would behave as an unbalanced 1:2 splitter, while the splitter 44 would serve as a 2:1 coupler.

FIG. 6C shows an alternative configuration to that of FIG. 6B, wherein an optical attenuator 72 is positioned in line with the phase shifter 48 in order to dynamically control both the amplitude and phase of the excitation vectors to correct for amplitude imbalances across the signal paths, or to reconfigure the beam shapes. The optical attenuator 72 may be implemented by any suitable device, such as an electro-absorption modulator (EAM), a microring resonator (MRR), an MZI, etc.

This embodiment is beneficial as the control circuitry and procedure has significantly reduced complexity over the optical Blass matrix in the prior art. The amplitude and phase components of each signal path in the feed network are determined by the single crossbar unit that couples the input signal from the row to the column for that particular input/output pair. The beam directions can therefore be controlled independently of one another by adjusting the phase shifters along the corresponding row/column, while the beam shape is determined by the coupling ratios along the corresponding row/column. This enables fast, real-time beam steering that scales well up to large array sizes, unlike the Blass matrix which requires spurious paths through the network to be recalculated each time the beam directions are adjusted. Furthermore, if the beam shape is fixed, then the power couplers can be implemented as passive devices which would reduce the number of control signals by half. This architecture also relaxes the requirements of the phase shifters as there is only one per signal path, therefore the loss of the phase modulator does not have a significant impact on the insertion loss of the full system.

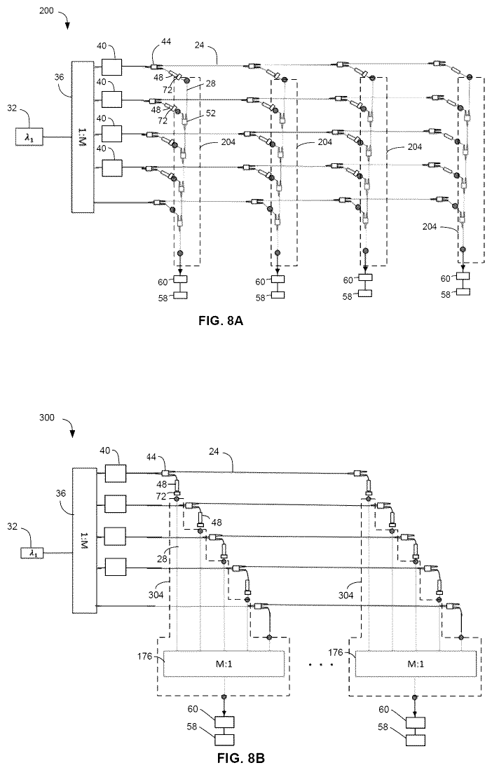

FIG. 7 shows a coherent multi-beam optical phased array for radio-frequency beamforming in accordance with another embodiment. Similar elements to those shown in FIGS. 6A and 6B are numbered the same and may not be re-described. In this embodiment, a secondary optical signal source 132 is used to generate a local oscillator for coherent detection. Alternatively, a signal can be split from the primary optical signal source 32 and used in place of the signal from the secondary optical signal source 132, thus reducing the number of lasers required in the system. Further, the feed network is modified to replace the cascaded 2:1 couplers along the vertical axis with a single M+1:1 combiner 176 per output. The M input signals and the signal from the secondary optical signal source 132 are coupled from the horizontal waveguides 24 into separate vertical waveguides 28 for each input and output pair, for a total of (M+1)*N vertical waveguides. The vertical waveguides are coupled across the adjacent horizontal waveguides through crossings, and into an array of optical phase shifters 48. The N groups of M phase-shifted signals and the optical local oscillator from the secondary optical signal source 132 are then combined into N output signals through a set of M+1:1 combiners 176. The M+1:1 combiners 176 are couplers that can couple two or more signals to form a single heterodyne signal.

The electrical interfaces are substantially the same as those of the embodiment illustrated in FIGS. 6A and 6B, with optical modulators 48 configured to produce an SSB-SC signal at the input, and coherent detection with carrier reinsertion at the output. The M+1:1 combiners 176 may be implemented by a network of Y-branches which offer broad bandwidth characteristics, or by a multi-mode interferometer which provides better balance across input channels and is robust to fabrication errors. Similar to the embodiment illustrated in FIGS. 6A and 6B, a variable optical attenuator may be inserted inline with the phase shifters 48 to control both the amplitude and phase of the excitation vectors for each beam.

The number of cascaded couplers in the signal path is reduced and replaced with a single M:1 combiner 176, which is generally less sensitive to fabrication errors than directional couplers or asymmetric multimode interferometers. Furthermore, the insertion loss may be improved in cases where the loss in the 2:1 couplers is high. The architecture of this embodiment also carries the same advantages over the prior art as the architecture of the embodiment illustrated in FIGS. 6A and 6B.

The architectures in the embodiments illustrated in FIGS. 6A and 7 may be modified using a multi-layer design to separate the input and output waveguides into different layers that are spatially offset and eliminate the waveguide crossings.

FIG. 8A shows an architecture for a coherent multi-beam optical phased array 200 for radio-frequency beamforming in accordance with another embodiment similar to that of FIG. 6A, wherein, after the 1:2 splitter 44 in each row (i.e., waveguide 24), the coupled signal propagates through the phase shifter 48 and optionally a variable optical attenuator (VOA) 72 before crossing into an adjacent layer that is spatially offset from the layer in which the first set of waveguides are positioned. Similar elements to those shown in FIGS. 6A and 6B are numbered the same and may not be re-described. After the layer transition, the signals are coupled into a single waveguide using serial cascaded 2:1 couplers 52. The elements positioned in the separate adjacent layer (that is, the columns and the 2:1 couplers 52) are indicated via region 204. The partitioning between layers in this case is chosen to ensure that all active devices are on the same layer to simplify the fabrication, however this need not be the case. For example, the layer transition could be placed in front of the phase shifters 48, so that the 2^{nd} layer contains both the phase shifters 48 and the couplers 52.

FIG. 8B shows an architecture for a coherent multi-beam optical phased array 300 for radio-frequency beamforming in accordance with another embodiment similar to that of FIG. 7, wherein, after the 1:2 splitter 44 in each row (i.e., waveguide 24), the coupled signal propagates through the phase shifter 48 and optionally a VOA 72 before crossing into an adjacent layer that is spatially offset from the layer in which the first set of waveguides are positioned. Similar elements to those shown in FIGS. 6A and 6B are numbered the same and may not be re-described. After the layer transition, the signals are coupled into a single waveguide using a parallel M:1 combiner 176. The elements positioned in the separate adjacent layer (that is, the columns and the M:1 combiners 176) are indicated via region 304. The partitioning between layers in this case is chosen to ensure that all active devices are on the same layer to simplify the fabrication, however this need not be the case. For example, the layer transition could be placed in front of the phase shifters 48, so that the 2^{nd} layer contains both the phase shifters 48 and the combiners 176.

The embodiments illustrated in FIGS. 8A and 8B eliminate the cascaded waveguide crossings from the feed network, which may reduce the insertion loss and crosstalk between signal paths depending on the size of the array and the performance of the crossings and layer transitions for a particular foundry process.

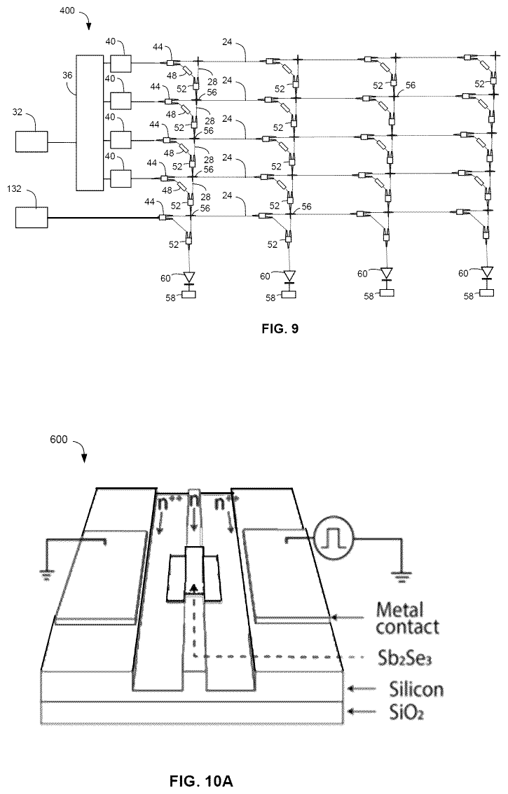

FIG. 9 illustrates an architecture for a coherent multi-beam optical phased array 400 for radio-frequency beamforming in accordance with a further embodiment wherein the feed network illustrated in FIG. 6A is modified to perform frequency up or down-conversion of the input signals in the optical domain. This can be achieved by replacing the reinserted carrier before the photodetector 60 by an optical local oscillator 132 with a frequency offset from the first optical carrier. The local oscillator 132 mixes with the modulated optical carrier in the photodetector 60, producing a photocurrent with a frequency equal to the difference between the carrier and local oscillator 132. For example, if the optical carrier has a frequency of f_{c}, the input electrical signal has a frequency of f_{RF} and the local oscillator 132 has a frequency of f_{L0}, then the electrical signals at the output of the beamformer would have a frequency of f_{RF+C-L0}. Therefore, the frequency of the output signal can be controlled by adjusting the frequency offset between the primary optical signal source 32 and the secondary optical signal source 132.

Incorporating frequency conversion in the optical domain can eliminate the need for electronic oscillators, mixers and filters. At mm Wave frequencies and above, the generation and distribution of oscillator signals is a significant challenge due to the bandwidth limitations of electrical systems. Generating and distributing the mm Wave signals for frequency up-conversion and down-conversion in the optical domain provides an efficient and cost-effective alternative that scales well into higher frequency bands.

As will be understood, while not expressly described and illustrated, the optical local oscillator architecture can be used with any of the other embodiments illustrated herein.

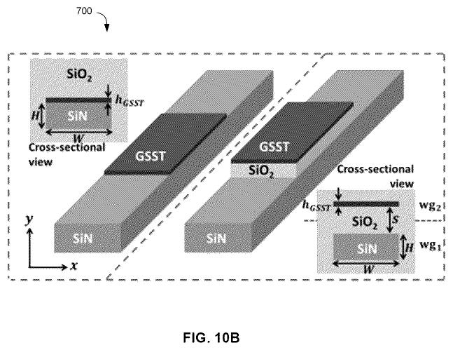

FIGS. 10A and 10B show two embodiments of phase change materials (PCM) phase shifters 600 and 700 respectively for use with any of the previously illustrated and described embodiments. In particular, the phase shifter 600 of FIG. 10A includes a layer of chalcogenide deposited on a waveguide layer. In particular, the layer of chalcogenide is an antimony-selenium (Sb₂Se₃) layer, and the waveguide layer is a silicon layer positioned atop of a silicon layer atop of silicon dioxide (SiO₂). The phase shifter 700 of FIG. 10B has a layer of chalcogenide and a waveguide layer that are a GSST (Ge₂Sb₂Se₄Te) layer and a silicon nitride (Si₃N₄) layer, optionally with a silicon dioxide (SiO₂) layer in between, in this particular example. The PCM phase shifters 600 and 700 generate the desired excitation vectors for each beam. PCMs are non-volatile devices based on chalcogenide alloys such as germanium-antimony-tellurium (GST), antimony-Sulphur (SbS), etc., and that can be rapidly switched between the crystalline and amorphous states to induce a change in the optical properties of the device. Depending on the material, these states can have a high index contrast while maintaining low absorption loss making them suitable for optical phase modulators, or they may undergo a large change in optical absorption, making them suitable as variable optical attenuators.

PCM devices are typically reconfigured by applying a voltage pulse to a microheater overlaid on the PCM strip to melt and rapidly recrystallize the device with a different amorphous-to-crystalline ratio. The crystallization ratio can be controlled by varying the duration or fall time of the programming pulse. The microheater can be fabricated using any suitable material and process, such as phosphorus-doping of the waveguide, or using an Indium-Tin-Oxide (ITO) thin film.

Unlike conventional optical phase shifters based on, for example, the thermo-optic or electro-optic effect, PCM devices do not use digital-to-analog converters (DAC) in the programming circuit as the tuning pulse has a fixed voltage with a varying width or fall time. This can be achieved using a CMOS current mirror circuit which has significantly lower area and power consumption in comparison to a DAC. Furthermore, a PCM phase shifter has no static power consumption as it is a non-volatile device, unlike TO or EO phase modulators that consume 10's or 100's of milliwatts to maintain a phase shift. The footprint of a PCM modulator is also very compact, with a length on the order of 10's of micrometers in most state-of-the-art demonstrations.

The above illustrated and described embodiments for coherent multi-beam optical phased arrays for radio-frequency beamforming ensure strong isolation between signal paths with one phase shifter per path. An array pattern can be synthesized independently for each beam with no or few spurious beams. The configuration dynamics of the beamformer are significantly simplified. Further, these embodiments enable the use of passive power splitters and couplers to eliminate the number of electrical control signals.

The use of PCM-based phase shifters to configure beam directions provides a number of advantages. There is zero or near-zero static power consumption. Smaller form factors are possible in comparison to TO or EO phase modulators. PCM-based phase shifters are programmed by CMOS current mirrors rather than digital-to-analog converters (DACs), which reduces the size and power of the programming circuit.

The architectures disclosed here are particularly advantageous for implementing an optoelectronically-steerable phased array antenna for 5G base stations employing SDM with massive MIMO technology employing spatial division multiplexing (SDM) to serve multiple users on the same time and frequency resources in frequency range 2 (24.25-71 GHz), particularly in the mm Wave frequency bands and above where hybrid beamforming architectures are beneficial due to the cost and power consumption of fully digital solutions. They are also applicable to higher frequency bands in the upper mm Wave and terahertz range, which is considered a promising technology for 6G wireless networks. Further, the principles illustrated and described herein can be applied to multi-beam RADAR systems, for example in scan-on-receive synthetic aperture RADARs, which is also a proposed application of the optical Blass matrix. Still further, the same principles can be applied to satellite communication systems, which would benefit greatly from the size, weight, and power improvements offered by photonic integrated circuits.

In other embodiments, the same approach described herein can be employed for other modalities.

All values and sub-ranges within disclosed ranges are also disclosed. Also, although the systems, devices and processes disclosed and shown herein may comprise a specific plurality of elements, the systems, devices and assemblies may be modified to comprise additional or fewer of such elements. Although several example embodiments are described herein, modifications, adaptations, and other implementations are possible. For example, substitutions, additions, or modifications may be made to the elements illustrated in the drawings.

Features from one or more of the above-described embodiments may be selected to create alternate embodiments comprised of a sub-combination of features which may not be explicitly described above. In addition, features from one or more of the above-described embodiments may be selected and combined to create alternate embodiments comprised of a combination of features which may not be explicitly described above. Features suitable for such combinations and sub-combinations would be readily apparent to persons skilled in the art upon review of the present disclosure as a whole.

In addition, numerous specific details are set forth to provide a thorough understanding of the example embodiments described herein. It will, however, be understood by those of ordinary skill in the art that the example embodiments described herein may be practiced without these specific details. Furthermore, well-known methods, procedures, and elements have not been described in detail so as not to obscure the example embodiments described herein. The subject matter described herein and in the recited claims intends to cover and embrace all suitable changes in technology.

Although the present invention and its advantages have been described in detail, it should be understood that various changes, substitutions and alterations can be made herein without departing from the invention as defined by the appended claims.

The present invention may be embodied in other specific forms without departing from the subject matter of the claims. The described example embodiments are to be considered in all respects as being only illustrative and not restrictive. The present disclosure intends to cover and embrace all suitable changes in technology. The scope of the present disclosure is, therefore, described by the appended claims rather than by the foregoing description. The scope of the claims should not be limited by the embodiments set forth in the examples, but should be given the broadest interpretation consistent with the description as a whole.

1. A coherent multi-beam optical phased array for radio-frequency beamforming, comprising:
an optical signal source generating an optical signal;
a first set of waveguides connected to the optical signal source and configured to propagate the optical signal;
a second set of waveguides;
a set of splitters along each of the first set of waveguides configured to split the optical signal;
a phase shifter coupled to each of the splitters, each of the phase shifters being controllable to modify a shift in a phase of the optical signal received from a corresponding splitter of the set of splitters;
a coupler connected to each of the phase shifters and to one waveguide of the second set of waveguides for introducing the optical signal after shifting; and
a photodetector coupled to each waveguide of the second set of waveguides and configured to receive a heterodyne optical signal from the waveguide and generate a corresponding electrical signal.

2. The coherent multi-beam optical phased array of claim 1, wherein at least one of the waveguides in the second set of waveguides is coupled to each of the waveguides in the first set of waveguides via a subset of the splitters.

3. The coherent multi-beam optical phased array of claim 1, further comprising:
an optical source signal splitter coupled to the optical signal source and configured to split the optical signal among a subset of the first set of waveguides.

4. The coherent multi-beam optical phased array of claim 3, further comprising:
an optical modulator positioned between the optical source signal splitter and each of the subset of the first set of waveguides.

5. The coherent multi-beam optical phased array of claim 1, wherein the first set of waveguides are in a first layer and wherein the second set of waveguides are in a second layer that is offset spatially from the first layer.

6. The coherent multi-beam optical phased array of claim 1, further comprising:
an optical local oscillator coupled to the second set of waveguides with a controllable frequency offset from the first optical signal to up-convert or down-convert the electrical signal generated at the photodetector.

7. The coherent multi-beam optical phased array of claim 1, wherein the phase shifter is a phase change materials phase shifter that includes a layer of chalcogenide deposited on a waveguide layer.

8. The coherent multi-beam optical phase array of claim 7, wherein the layer of chalcogenide is one of an antimony-selenium layer and a GSST (Ge₂Sb₂Se₄Te) layer, and wherein the waveguide layer is one of a silicon layer and a silicon nitride (Si₃N₄) layer.

9. A coherent multi-beam optical phased array for radio-frequency beamforming, comprising:
an optical signal source generating an optical signal;
a first set of waveguides connected to the optical signal source and configured to propagate the optical signal;
a second set of waveguides;
a set of splitters along each of the first set of waveguides configured to split the optical signal;
a phase shifter coupled to each of the splitters, each of the phase shifters being controllable to modify a shift in a phase of the optical signal received from a corresponding splitter of the set of splitters, the phase shifter being coupled to one of the wave guides in the second set of waveguides;
a coupler connected to the waveguides in the second set of waveguides extending from at least two of the phase shifters for combining the optical signal after shifting by the at least two phase shifters; and
a photodetector coupled to each coupler and configured to receive a heterodyne optical signal from the coupler and generate a corresponding electrical signal.

10. The coherent multi-beam optical phased array of claim 9, wherein the coupler combines the optical signal after shifting from each of the first set of waveguides.

11. The coherent multi-beam optical phased array of claim 9, further comprising:
an optical source signal splitter coupled to the optical signal source and configured to split the optical signal among a subset of the first set of waveguides.

12. The coherent multi-beam optical phased array of claim 11, further comprising:
an optical modulator positioned between the optical source signal splitter and each of the subset of the first set of waveguides.

13. The coherent multi-beam optical phased array of claim 9, wherein the first set of waveguides are in a first layer and wherein the second set of waveguides are in a second layer that is offset spatially from the first layer.

14. The coherent multi-beam optical phased array of claim 9, further comprising:
an optical local oscillator coupled to the second set of waveguides with a controllable frequency offset from the first optical signal to up-convert or down-convert the electrical signal generated at the photodetector.

15. The coherent multi-beam optical phased array of claim 9, wherein the phase shifter is a phase change materials phase shifter that includes a layer of chalcogenide deposited on a waveguide layer.

16. The coherent multi-beam optical phased array of claim 15, wherein the layer of chalcogenide is one of an antimony-selenium layer and a GSST (Ge₂Sb₂Se₄Te) layer, and the waveguide layer is one of a silicon layer and a silicon nitride (Si₃N₄) layer.

17. A coherent multi-beam optical phased array for radio-frequency beamforming, comprising:
a phase change materials phase shifter.

18. The coherent multi-beam optical phased array of claim 17, wherein the phase change materials phase shifter includes a layer of chalcogenide deposited on a waveguide layer.

19. The coherent multi-beam optical phased array of claim 18, wherein the layer of chalcogenide is one of an antimony-selenium layer and a GSST (Ge₂Sb₂Se₄Te) layer.

20. The coherent multi-beam optical phased array of claim 18, wherein the waveguide layer is one of a silicon layer and a silicon nitride (Si₃N₄) layer.

21. The coherent multi-beam optical phased array of claim 18, wherein a silicon dioxide (SiO₂) layer is positioned between the layer of chalcogenide and the waveguide layer.
